(19) United States
(12) Patent Application Publication
(10) Pub. No.: US 2025/0055220 A1
(43) Pub. Date: Feb. 13, 2025

(54) ELECTRIC WIRE WITH CONNECTOR AND METHOD OF MANUFACTURING THE SAME

(71) Applicant: YAZAKI CORPORATION, Tokyo (JP)

(72) Inventors: Fuminori KONDO, Shizouka (JP); Yusaku Ohki, Shizuoka (JP); Hiroyuki Tanaka, Shizouka (JP)

(73) Assignee: YAZAKI CORPORATION, Tokyo (JP)

(21) Appl. No.: 18/931,241

(22) Filed: Oct. 30, 2024

Related U.S. Application Data
(63) Continuation of application No. PCT/JP2023/037508, filed on Oct. 17, 2023.

(30) Foreign Application Priority Data
Oct. 17, 2022 (JP) 2022-166053

(51) Int. Cl. H01R 13/52; H01R 13/502; H01R 43/00

(52) U.S. Cl. CPC H01R 13/5202; H01R 13/502; H01R 43/005; H01R 2201/26

(57) ABSTRACT

In an electric wire with a connector, an entire periphery of a second portion of an electric wire is surrounded by an adhesive. An entire periphery of a coupler is surrounded by the adhesive. A recess is disposed in at least either a first case or a second case. A conductor connector is sealed in a space formed by the recess, of which an entire periphery is surrounded by the first case, the second case, and the adhesive.

### CROSS-REFERENCE TO RELATED APPLICATIONS

The present application is a continuation of International Application No. PCT/JP2023/037508, filed on Oct. 17, 2023, and based upon and claims the benefit of priority from Japanese Patent Application No. 2022-166053, filed on Oct. 17, 2022, the entire contents of which are incorporated herein by reference.

### TECHNICAL FIELD

The present disclosure relates to an electric wire with a connector and a method of manufacturing an electric wire with a connector.

### BACKGROUND

There is a prior known electric wire with a terminal having an electric wire, and a terminal connected to a conductor of the electric wire. If this kind of electric wire with the terminal is used in a place such as an engine room of an automobile where water may enter, water may adhere to a connection portion between the terminal and the conductor of the electric wire, and the terminal and the conductor may be corroded. Therefore, an electric wire with a terminal has been known in which a connection portion between a terminal and a conductor is covered with a heat-shrinkable tube to prevent water from entering the connection portion.

JP 2000-285983 A discloses a waterproof structure of a ground terminal for an automobile. In this structure, a core wire is press-fastened and crimped with a core wire crimping barrel, and an insulation sheath of an electric wire is press-fastened and crimped with an insulation sheath crimping barrel. One end side of a heat-shrinkable tube completely covers the core wire press-fastened and crimped with the core wire crimping barrel, and the other end side is in close contact with the electric wire. An adhesive is applied to an inner peripheral surface of the heat-shrinkable tube, and the adhesive adheres to the ground terminal and the electric wire to eliminate a gap.

### SUMMARY OF THE INVENTION

According to JP 2000-285983 A, the adhesive applied to the inner peripheral surface of the heat-shrinkable tube fills a gap between core wires to prevent water from entering between a plurality of element wires. However, there is a risk that the adhesive may not sufficiently penetrate to a center portion of a conductor due to variations in each element wire diameter and each conductor diameter. In particular, when the electric wire is used in a bent state while a gap remains between conductors, the gap between the core wires becomes large, and there is a risk that water may easily enter an end of the electric wire.

The present disclosure has been devised in view of the problems of the previously existing technology. An object of the present disclosure is to provide an electric wire with a connector capable of preventing water from entering a terminal of an electric wire.

An electric wire with a connector according to an aspect of the present disclosure includes an electric wire that includes a conductor and an insulation sheath covering an outer periphery of the conductor, and that includes therein a conductor exposed portion in which the conductor is exposed from the insulation sheath, and a conductor covered portion in which the conductor is covered with the insulation sheath. The electric wire with a connector includes a terminal that includes a conductor connector connected to the conductor exposed portion, a terminal connector configured to be connected to a mating terminal, and a coupler coupling the conductor connector and the terminal connector. The electric wire with a connector includes a housing that includes a first case and a second case, and that has an adhesive interposed between a whole circumference of an edge of the first case and a whole circumference of an edge of the second case. A first portion of the conductor covered portion and the terminal connector are exposed from the housing. A second portion of the conductor covered portion that is disposed more toward the conductor exposed portion than the first portion is sandwiched between a portion of the edge of the first case and a portion of the edge of the second case through the adhesive, and due to an entire periphery of the second portion of the electric wire being surrounded by the adhesive, water is prevented from entering from between the housing and the electric wire. The coupler is sandwiched between the portion of the edge of the first case and the portion of the edge of the second case through the adhesive, and due to an entire periphery of the coupler being surrounded by the adhesive, water is prevented from entering from between the housing and the coupler. A recess is disposed in at least either the first case or the second case. The conductor connector is sealed in a space formed by the recess, of which an entire periphery is surrounded by the first case, the second case, and the adhesive, and the adhesive prevents water from entering from between the first case and the second case.

A method of manufacturing an electric wire with a connector according to another aspect of the present disclosure includes: a step of connecting a conductor exposed portion in which a conductor is exposed from an insulation sheath covering an outer periphery of the conductor, to a conductor connector configured to be connected to the conductor exposed portion, the conductor exposed portion being included in an electric wire that includes the conductor and the insulation sheath, and that includes therein the conductor exposed portion and a conductor covered portion in which the conductor is covered with the insulation sheath, the conductor connector being included in a terminal that includes the conductor connector, a terminal connector configured to be connected to a mating terminal, and a coupler coupling the conductor connector and the terminal connector; and a step of sandwiching an entire periphery of the conductor covered portion and an entire periphery of the coupler by an adhesive with a self-adhesive property formed to a whole circumference of an edge of a first case, an adhesive formed to at least an edge of a second case to which the conductor covered portion is attached, and an adhesive formed to at least an edge of the second case to which the coupler is attached; preventing water from entering from between the electric wire, and a housing including the first case and the second case, from between the housing and the coupler, and from between the first case and the second case by the adhesive formed to the edge of the first case and the adhesive formed to the edge of the second case; and sealing the conductor connector in a space formed by a recess, of which an entire periphery is surrounded by the first case, the second case, and the adhesive, the recess being disposed in at least either the first case or the second case.

According to the present disclosure, it is possible to provide an electric wire with a connector capable of preventing water from entering a terminal of an electric wire.

### BRIEF DESCRIPTION OF DRAWINGS

FIG. 1 is a perspective view schematically illustrating an example of an electric wire with a connector according to the present embodiment.

FIG. 2 is a side view schematically illustrating an example of the electric wire with a connector according to the present embodiment.

FIG. 3 is a schematic cross sectional view taken along line III-III of FIG. 2.

FIG. 4 is a schematic cross sectional view taken along line IV-IV of FIG. 2.

FIG. 5 is a cross sectional view taken along line V-V of FIG. 4.

FIG. 6 is a side view schematically illustrating an example of a state where an insulation sheath of an electric wire is peeled off.

FIG. 7 is a schematic cross sectional view illustrating an example of a state in which a terminal is connected to a conductor of the electric wire.

FIG. 8 is a side view schematically illustrating a state in which a sealing agent is applied to an edge of a first case.

FIG. 9 is a plan view schematically illustrating the state in which the sealing agent is applied to the edge of the first case.

FIG. 10 is a side view schematically illustrating a state in which a sealing agent is applied to an edge of a second case.

FIG. 11 is a plan view schematically illustrating the state in which the sealing agent is applied to the edge of the second case.

FIG. 12 is a plan view schematically illustrating another example of a state in which a sealing agent is applied to an edge of a second case.

FIG. 13 is a plan view schematically illustrating another example of a state in which a sealing agent is applied to an edge of a second case.

### DETAILED DESCRIPTION OF THE INVENTION

An electric wire with a connector and a method of manufacturing an electric wire with a connector according to the present embodiment will be described in detail below with reference to the drawings. Note that dimensional ratios in the drawings are exaggerated for convenience of the description, and may be different from actual ratios. Further, in the present embodiment, a description will be given by assuming that an X direction is an axial direction of a conductor, a Y direction is a depth direction of a connector perpendicular to the X direction, and a Z direction is a height direction of the connector perpendicular to the X direction and Y direction.

[Electric Wire with Connector]

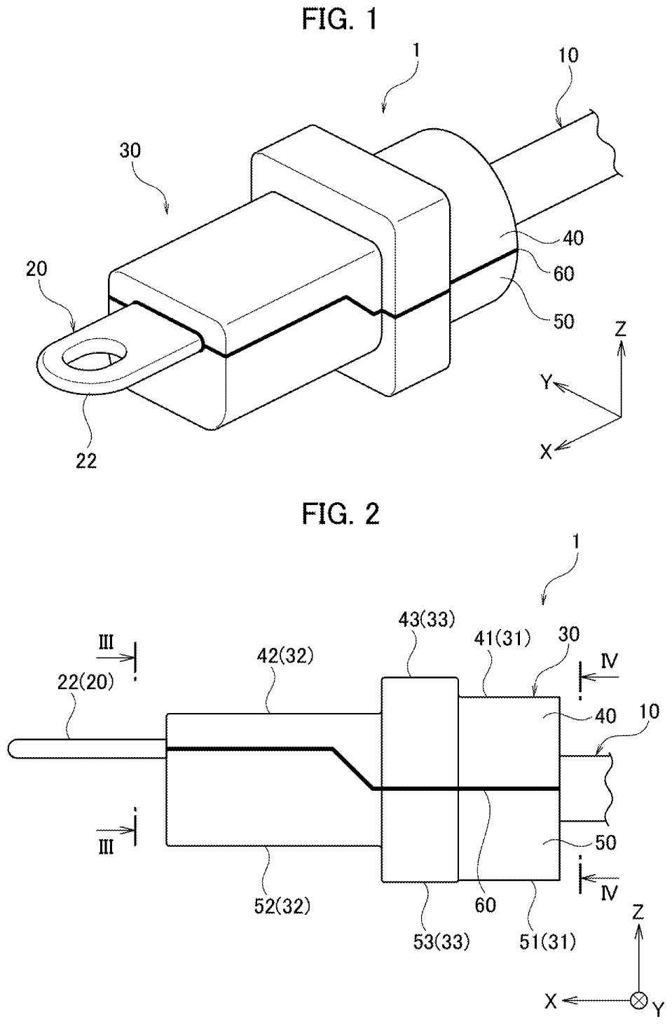

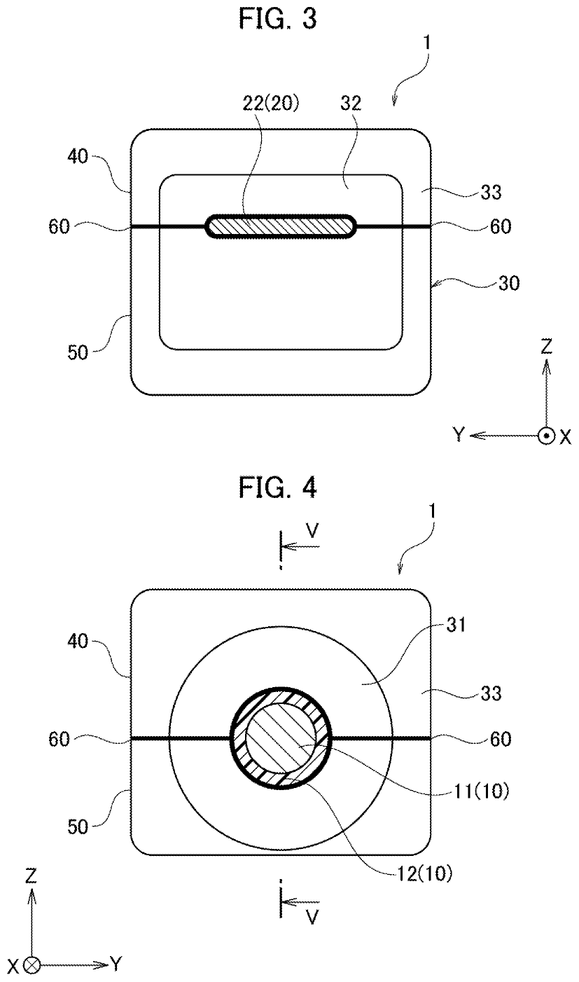

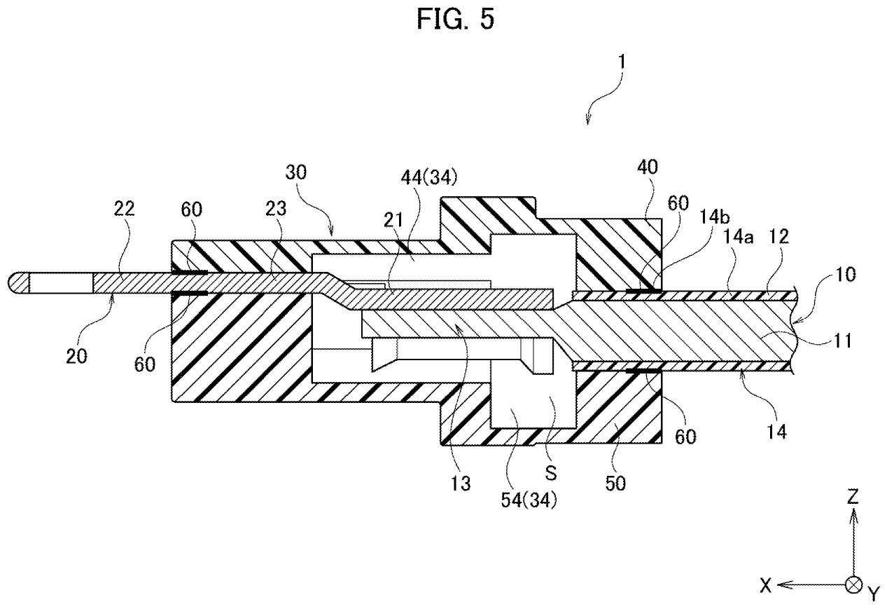

First, an electric wire 1 with a connector according to the present embodiment will be described. FIG. 1 is a perspective view schematically illustrating an example of the electric wire 1 with the connector according to the present embodiment. FIG. 2 is a side view schematically illustrating an example of the electric wire 1 with the connector according to the present embodiment. FIG. 3 is a schematic cross sectional view taken along line III-III of FIG. 2. FIG. 4 is a schematic cross sectional view taken along line IV-IV of FIG. 2. FIG. 5 is a cross sectional view taken along line V-V of FIG. 4.

As illustrated in FIGS. 1 to 5, the electric wire 1 with the connector according to the present embodiment includes an electric wire 10, a terminal 20, and a housing 30. In the present embodiment, the electric wire 1 with the connector is a male connector.

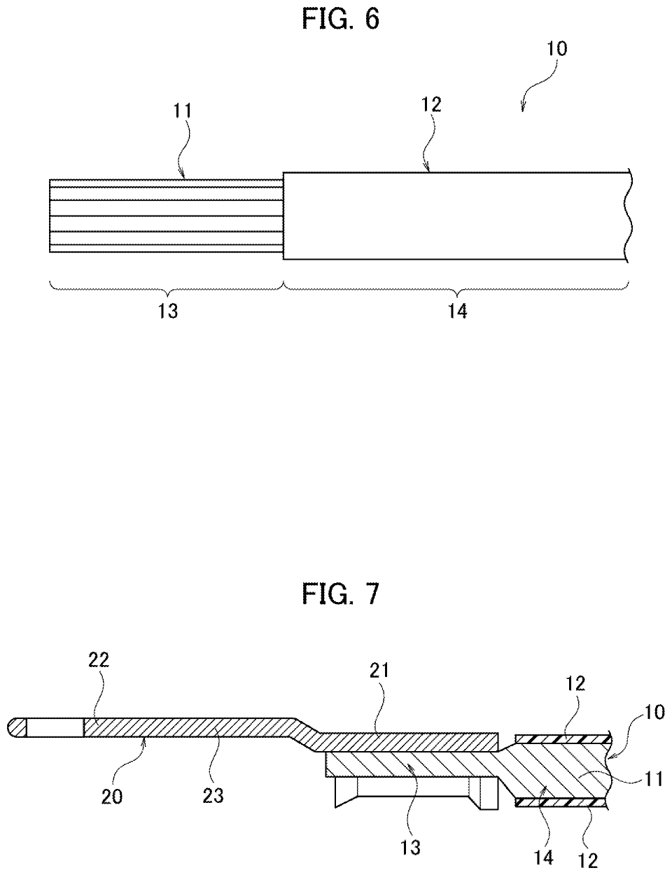

FIG. 6 is a side view schematically illustrating an example of a state in which an insulation sheath 12 of the electric wire 10 is peeled off. The electric wire 10 includes a conductor 11 and the insulation sheath 12 covering the outer periphery of the conductor 11. The electric wire 10 has a conductor exposed portion 13 in which the insulation sheath 12 is peeled off and the conductor 11 is exposed from the insulation sheath 12. Further, the electric wire 10 has a conductor covered portion 14 in which the conductor 11 is covered with the insulation sheath 12. The conductor exposed portion 13 is disposed at an end of the conductor 11.

The conductor 11 may be constituted by only one element wire, or may be an aggregated twisted wire constituted by bundling a plurality of element wires. Further, the conductor 11 may be constituted by only one twisted wire, or may be a composite twisted wire constituted by bundling a plurality of aggregated twisted wires.

As a material of the conductor 11, highly conductive metal can be used. A material of the conductor 11 may be copper, aluminum, or an alloy thereof, for example.

As a material of the insulation sheath 12, it is possible to use a thermoplastic resin that can ensure electrical insulation. A material of the insulation sheath 12 may contain at least one of an olefin-based resin and polyvinyl chloride, for example. The olefin-based resin may contain at least one or more resins selected from the group consisting of polyethylene (PE), polypropylene (PP), an ethylene copolymer, and a propylene copolymer, for example.

The terminal 20 includes a conductor connector 21, a terminal connector 22, and a coupler 23. The conductor connector 21 is disposed at one end of the terminal 20, and the terminal connector 22 is disposed at the other end of the terminal 20.

The conductor connector 21 is connected to the conductor exposed portion 13. The conductor connector 21 is configured to be mechanically and electrically connected to the conductor 11 due to being connected to the conductor exposed portion 13 of the electric wire 10. The conductor connector 21 covers the conductor exposed portion 13 so as to surround a circumferential direction of the conductor 11.

The terminal connector 22 is configured to be connected to a mating terminal (not illustrated). Due to the terminal connector 22 being connected to a terminal connector of the mating terminal, the terminal 20 is mechanically and electrically connected to the mating terminal. The terminal connector 22 protrudes from a surface of the housing 30 and is exposed. In a cut surface obtained by cutting the terminal connector 22 in a YZ plane perpendicular to the X direction, the terminal connector 22 has an approximate rectangular shape in which the Y direction is a longitudinal direction and the Z direction is a thickness direction, and the terminal connector 22 extends in the X direction. An end of the terminal connector 22 in the X direction has a semicircular shape, and a through hole is formed in a center portion of the end of the terminal connector 22. However, there are no particular limitations on the shape of the terminal connector 22, and the terminal connector 22 may have other shapes such as a prism shape.

The coupler 23 couples the conductor connector 21 and terminal connector 22. Specifically, the coupler 23 is interposed between the conductor connector 21 and terminal connector 22. In the present embodiment, the terminal 20 is formed by continuously and integrally forming the conductor connector 21, terminal connector 22, and coupler 23 using one material. However, the terminal 20 may be formed by combining the conductor connector 21, terminal connector 22, and coupler 23, which are separated from each other. The terminal 20 is formed of a conductive material. A material forming the terminal 20 may contain at least one metal selected from the group consisting of copper, aluminum, iron, and magnesium, for example. A surface of the terminal 20 may or may not be plated.

Although an example of the terminal 20 has been described, a specific shape of the terminal 20 is not particularly limited, and the terminal 20 having any shape may be used.

The housing 30 has a first case 40 and a second case 50. In the present embodiment, the first case 40 is an upper case and the second case 50 is a lower case. However, alternatively, the second case 50 may be an upper case and the first case 40 may be a lower case. As illustrated in FIG. 9, the first case 40 has an edge 40a, and an adhesive 60 formed by curing a sealing agent 70 is formed at the edge 40a of the first case 40 (see FIGS. 2 to 5). As illustrated in FIG. 11, the second case 50 has an edge 50a, and an adhesive 60 formed by curing a sealing agent 70 is formed at the edge 50a of the second case 50 (see FIGS. 2 to 5). Further, an adhesive is interposed between the whole circumference of the edge 40a of the first case 40 and the whole circumference of the edge 50a of the second case 50. Still further, as illustrated in FIG. 5, a first portion 14a of the conductor covered portion 14 and the terminal connector 22 are exposed from the housing 30. The first case 40 and second case 50 may be connected by means of fitting. The housing 30 may have a lock structure where the first case 40 and second case 50 are engaged to prevent the first case 40 and second case 50 from being detached.

As illustrated in FIG. 2, the housing 30 includes an electric wire holder 31, a terminal holder 32, and a flange 33. The electric wire holder 31 is disposed at one end of the housing 30 in the X direction, and the terminal holder 32 is disposed at the other end of the housing 30 in the X direction. The flange 33 is interposed between the electric wire holder 31 and terminal holder 32 in the X direction.

The electric wire holder 31 includes a first electric wire holder 41 of the first case 40 and a second electric wire holder 51 of the second case 50. The first electric wire holder 41 and second electric wire holder 51 of the electric wire holder 31 are connected with the adhesive 60 therebetween, and the electric wire 10 is sandwiched therebetween. Specifically, a second portion 14b of the conductor covered portion 14 which is disposed more toward the conductor exposed portion 13 than the first portion 14a is sandwiched between a portion of the edge 40a of the first case 40 and a portion of the edge 50a of the second case 50 through the adhesive 60. Due to the entire periphery of the second portion 14b of the electric wire 10 being surrounded by the adhesive 60, water is prevented from entering from between the housing 30 and electric wire 10. The electric wire holder 31 has a square tubular shape and covers the periphery of the insulation sheath 12 of the electric wire 10.

The terminal holder 32 includes a first terminal holder 42 of the first case 40 and a second terminal holder 52 of the second case 50. The first terminal holder 42 and second terminal holder 52 of the terminal holder 32 are connected with the adhesive 60 therebetween, and the terminal 20 is sandwiched therebetween. Specifically, the coupler 23 is sandwiched between a portion of the edge 40a of the first case 40 and a portion of the edge 50a of the second case 50 through the adhesive 60. Due to the entire periphery of the coupler 23 being surrounded by the adhesive 60, water is prevented from entering from between the housing 30 and coupler 23.

The flange 33 includes a first flange 43 of the first case 40 and a second flange 53 of the second case 50. The flange 33 is formed of the first flange 43 and second flange 53. The flange 33 extends such that the flange 33 is spread more toward the Y direction and Z direction than the terminal holder 32.

When viewed from an XY plane, the first case 40 has a recess 44 (recess 34) of which entire periphery is surrounded by the adhesive 60 disposed at the edge 40a. Further, when viewed from the XY plane, the second case 50 has a recess 54 (recess 34) of which entire periphery is surrounded by the adhesive 60 disposed at the edge 50a. When viewed from the XY plane, the edge 40a is disposed so as to surround the recess 44, and the edge 50a is disposed so as to surround the recess 54. The edge 40a and edge 50a are disposed so as to face each other in the Z direction. The first case 40 and second case 50 are connected with the adhesive 60 therebetween, while the recess 44 of the first case 40 and the recess 54 of the second case 50 of the housing 30 face each other. Accordingly, a continuous space S formed by combining the recess 44 and recess 54 is formed.

The conductor connector 21 is sealed in the space S formed by the recess 34, of which entire periphery is surrounded by the first case 40, second case 50, and adhesive 60. Further, the adhesive 60 prevents water from entering from between the first case 40 and second case 50. With this configuration, it is possible to prevent a liquid such as water from entering the space S from the outside of the housing 30. Therefore, since it is possible to prevent a liquid from adhering to the conductor connector 21, it is possible to prevent water from entering the electric wire 10.

In the present embodiment, an example is described in which the recess 34 includes the recess 44 and recess 54. However, the present embodiment is not limited to such an example, and the recess 34 may be disposed only in either the first case 40 or the second case 50. That is, it is sufficient if the recess 34 is disposed in at least either the first case 40 or the second case 50.

The adhesive 60 is adhered to the first case 40 and second case 50. The adhesive 60 is directly adhered to the edge 40a of the first case 40, the edge 50a of the second case 50, an entire circumferential direction of the insulation sheath 12, and an entire circumferential direction of the terminal 20. The adhesive 60 is formed integrally and continuously.

The adhesive 60 has a self-adhesive property. Here, the self-adhesive property means that the adhesives 60 are adhered to each other and integrated due to diffusion of molecular chains. The adhesive 60 may be a pressure sensitive adhesive. Here, the pressure sensitive adhesive refers to an adhesive having adhesiveness at a normal temperature (23° C.).

A glass transition temperature of the adhesive 60 may be 0° C. or lower. Due to the glass transition temperature of the adhesive 60 being 0° C. or lower, it is possible to increase the adhesiveness of the adhesive 60.

The adhesive 60 may be at least one adhesive selected from the group consisting of a silicone adhesive, an acrylic adhesive, a rubber adhesive, and a urethane adhesive. The adhesive 60 may be a UV curable resin or a thermosetting resin. However, from the viewpoint of workability, the adhesive 60 is preferably a UV curable resin.

The acrylic adhesive is an adhesive containing a (meth)acrylic polymer. The acrylic adhesive contains a polymer polymerized at least one monomer of acrylate and methacrylate, and has (meth)acrylate as a structural unit. The (meth)acrylate is a concept including acrylate and methacrylate. The (meth)acrylate used in the acrylic adhesive may contain at least one selected from the group consisting of ethyl (meth)acrylate, propyl (meth)acrylate, butyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, and decyl (meth)acrylate.

The rubber adhesive may contain at least one rubber selected from the group consisting of butyl rubber, ethylene-propylene rubber (EPM), ethylene-propylene-diene rubber (EPDM), and natural rubber.

The silicone adhesive contains silicone rubber. The silicone rubber has a main chain composed of siloxane bonds. A side chain of the silicone rubber may be substituted with at least one substituent selected from the group consisting of a methyl group, a phenyl group, and a vinyl group. The silicone adhesive may contain organopolysiloxane having dimethylsiloxane as a main structural unit, for example.

The urethane adhesive contains polyurethane. Polyurethane is a polymer having a urethane bond and can be obtained by condensing an isocyanate group and a compound having a hydroxy group.

As described above, the electric wire 1 with the connector includes the electric wire 10. The electric wire 10 includes the conductor 11 and the insulation sheath 12 covering the outer periphery of the conductor 11, and further includes therein the conductor exposed portion 13 in which the conductor 11 is exposed from the insulation sheath 12, and the conductor covered portion 14 in which the conductor 11 is covered with the insulation sheath 12. The electric wire 1 with the connector includes the terminal 20. The terminal 20 includes the conductor connector 21 connected to the conductor exposed portion 13, the terminal connector 22 configured to be connected to a mating terminal, and the coupler 23 for coupling the conductor connector 21 and terminal connector 22. The electric wire 1 with the connector includes the housing 30. The housing 30 includes the first case 40 and second case 50 and in the housing 30, the adhesive 60 is interposed between the whole circumference of the edge 40a of the first case 40 and the whole circumference of the edge 50a of the second case 50. The first portion 14a of the conductor covered portion 14 and the terminal connector 22 are exposed from the housing 30. The second portion 14b of the conductor covered portion 14 which is disposed more toward the conductor exposed portion 13 than the first portion 14a is sandwiched between a portion of the edge 40a of the first case 40 and a portion of the edge 50a of the second case 50 through the adhesive 60. Due to the entire periphery of the second portion 14b of the electric wire 10 being surrounded by the adhesive 60, water is prevented from entering from between the housing 30 and electric wire 10. The coupler 23 is sandwiched between a portion of the edge 40a of the first case 40 and a portion of the edge 50a of the second case 50 through the adhesive 60. Due to the entire periphery of the coupler 23 being surrounded by the adhesive 60, water is prevented from entering from between the housing 30 and coupler 23. The recess 34 is disposed in at least either the first case 40 or the second case 50. The conductor connector 21 is sealed in the space S formed by the recess 34, of which entire periphery is surrounded by the first case 40, second case 50, and adhesive 60. The adhesive 60 prevents water from entering from between the first case 40 and second case 50.

In the electric wire 1 with the connector according to the present embodiment, the entire periphery of the second portion 14b of the electric wire 10, the entire periphery of the coupler 23, and the entire periphery of the recess 34 are surrounded by the adhesive 60. The conductor connector 21 is sealed in the space S, in which the recess 34 is surrounded by the first case 40, second case 50, and adhesive 60. Therefore, water can be prevented from entering a terminal of the electric wire 10.

Further, the electric wire 1 with the connector can be reduced in size and weight, because in the electric wire 1 with the connector according to the present embodiment, the entire periphery of the second portion 14b of the electric wire 10, the entire periphery of the coupler 23, and the entire periphery of the recess 34 are surrounded by the adhesive 60. When a portion between the terminal 20 and housing 30 is mechanically sealed with a rubber component such as a packing, it is necessary to use a rubber component having a diameter matching the width of the coupler 23, for example. Further, when a portion between the electric wire 10 and housing 30 is mechanically sealed with a rubber component such as a rubber plug, it is necessary to dispose a rear holder in the housing 30, for example. Therefore, when a mechanical seal is performed using these rubber components, there is a risk that the size of the electric wire 1 with the connector may increase. However, the adhesive 60 is used in the electric wire 1 with the connector according to the present embodiment, and this eliminates the necessity to dispose a rear holder in the housing 30, for example. Therefore, the electric wire 1 with the connector can be reduced in size and weight. When the electric wire 1 with the connector is mounted on a mobile body such as an automobile, the mobile body can be reduced in weight, for example. This can increase the energy efficiency required for movement and can reduce the amount of emission of carbon dioxide into the atmosphere.

Further, as compared with the case where a conventional heat-shrinkable tube having an adhesive applied on an inner peripheral surface is used, there is a possibility that the amount of adhesive used can be reduced. In such a case, it is possible to contribute to the improvement of environmental problems.

[Method of Manufacturing Electric Wire with Connector]

Next, a method of manufacturing the electric wire 1 with the connector according to the present embodiment will be described. The method of manufacturing the electric wire 1 with the connector according to the present embodiment includes a conductor exposing step, a connecting step, an adhesive forming step, and a sealing step.

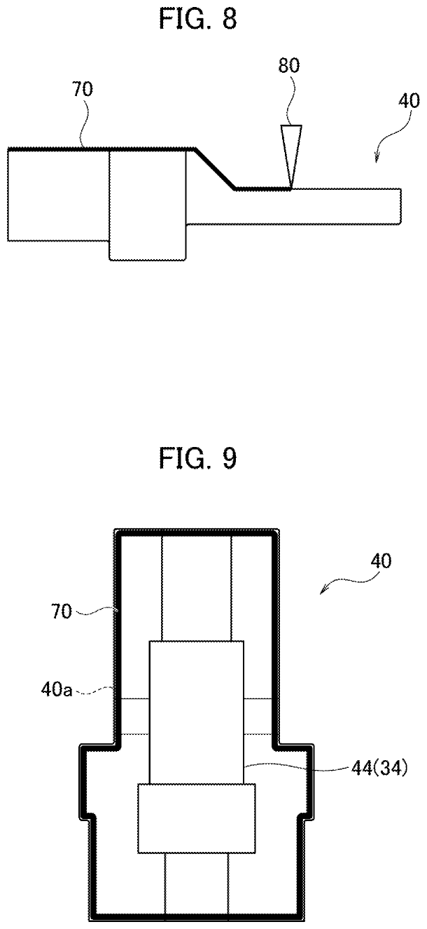

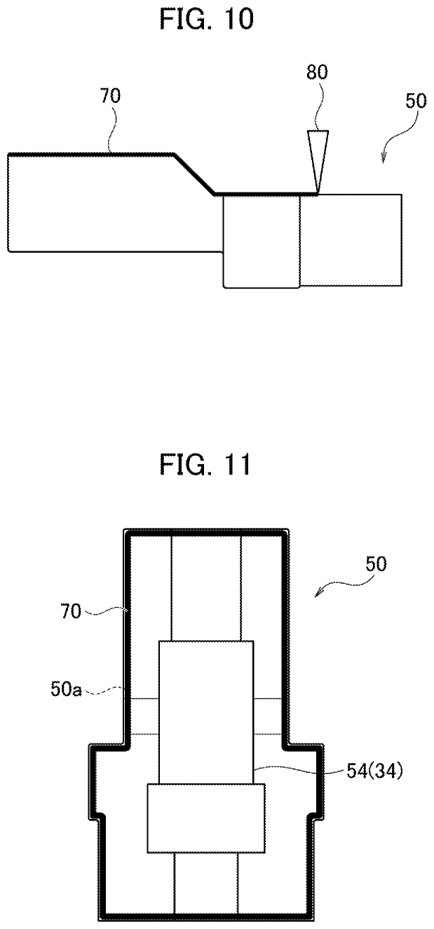

FIG. 6 is a schematic side view illustrating an example of a state in which the insulation sheath 12 of the electric wire 10 is peeled off by performing the conductor exposing step. FIG. 7 is a schematic cross sectional view illustrating an example of a state in which the terminal 20 is connected to the conductor 11 of the electric wire 10 by performing the connecting step. FIG. 8 is a side view schematically illustrating a state in which the sealing agent 70 is applied to the edge 40a of the first case 40 by performing the adhesive forming step. FIG. 9 is a plan view schematically illustrating a state in which the sealing agent 70 is applied to the edge 40a of the first case 40 by performing the adhesive forming step. FIG. 10 is a side view schematically illustrating a state in which the sealing agent 70 is applied to the edge 50a of the second case 50. FIG. 11 is a plan view schematically illustrating a state in which the sealing agent 70 is applied to the edge 50a of the second case 50.

### (Conductor Exposing Step)

In the conductor exposing step, first, the electric wire 10 is prepared. The electric wire 10 includes the conductor 11 and the insulation sheath 12 covering the outer periphery of the conductor 11. Next, a portion of the insulation sheath 12 of the electric wire 10 is peeled off. As a result, as illustrated in FIG. 6, the electric wire 10 has the conductor exposed portion 13 in which the conductor 11 is exposed from the insulation sheath 12, and the conductor covered portion 14 in which the conductor 11 is covered with the insulation sheath 12.

### (Connecting Step)

In the connecting step, the electric wire 10 is prepared, which has the conductor exposed portion 13 and conductor covered portion 14. Further, the terminal 20 is prepared, which has the conductor connector 21 configured to be connected to the conductor exposed portion 13, the terminal connector 22 configured to be connected to a mating terminal, and the coupler 23 for coupling the conductor connector 21 and terminal connector 22. Next, as illustrated in FIG. 7, the conductor exposed portion 13 of the electric wire 10 is connected to the conductor connector 21 of the terminal 20. This mechanically and electrically connects the conductor 11 of the electric wire 10 to the terminal 20.

### (Adhesive Forming Step)

The adhesive forming step includes a first adhesive forming step and a second adhesive forming step. In the first adhesive forming step, as illustrated in FIGS. 8 and 9, the sealing agent 70 is applied and cured to the whole circumference of the edge 40a of the first case 40. Then, the adhesive 60 with a self-adhesive property is formed to the whole circumference of the edge 40a of the first case 40. The entire periphery of the recess 44 is surrounded by the adhesive 60 disposed at the edge 40a of the first case 40. In the second adhesive forming step, as illustrated in FIGS. 10 and 11, the sealing agent 70 is applied and cured to the whole circumference of the edge 50a of the second case 50. Then, the adhesive 60 with a self-adhesive property is formed to the whole circumference of the edge 50a of the second case 50. The entire periphery of the recess 54 is surrounded by the adhesive 60 disposed at the edge 50a of the second case 50.

In the present embodiment, the adhesive 60 can be formed by applying and curing the sealing agent 70. Therefore, the workability in the present embodiment is higher than that of the case where molding is performed using a rubber gasket, and the electric wire 1 with the connector can be easily manufactured even with a small component having a small installation area. At least either the first case 40 or the second case 50 may have a positioning structure for the terminal 20. This structure facilitates the assembly of the terminal 20. There are no particular limitations as long as the adhesive 60 can be formed by applying and curing the sealing agent 70. A sealing agent 70 applied to the first case 40 and a sealing agent 70 applied to the second case 50 may be the same or different. An example of the sealing agent 70 is Born2Bond (registered trademark) CIPG AU588 manufactured by Bostik, an Arkema company.

There are no particular limitations on a method of applying the sealing agent 70 to the first case 40 or second case 50, and the sealing agent can be applied using an applicator 80 such as a dispenser, for example. The sealing agent 70 may be applied manually to the first case 40 or second case 50, or the sealing agent 70 may be applied to a predetermined position using an automatic applicator. The sealing agent 70 may be applied linearly, for example. The application width of the sealing agent 70 may be 2 mm or more and 4 mm or less, for example.

There are no particular limitations on a method of curing the sealing agent 70, and the sealing agent 70 may be cured by irradiating the applied sealing agent 70 with UV, for example. Examples of a light source capable of emitting UV include a xenon lamp, a high-pressure mercury lamp, a metal halide lamp, and an LED lamp. Conditions such as the UV irradiation amount are not particularly limited, and conditions may be appropriately set in accordance with specifications of the sealing agent 70.

The sealing agent 70 may have thixotropic properties. Here, the thixotropic properties means properties with time-dependent flow characteristics in which the apparent viscosity decreases over time under a constant shear rate condition and the viscosity gradually recovers when the shear stress is removed.

A thixotropic index (TI) value of the sealing agent 70 may be 2 or more. Due to the TI value of the sealing agent 70 being 2 or more, it is possible to prevent the shape of the applied sealing agent 70 from being deformed due to dripping. A TI value of the sealing agent 70 may be 3 or more, 4 or more, 5 or more, or 6 or more. Although there are no particular limitations on the upper limit of a TI value, a TI value may be 20 or less, for example. In the specification, a TI value means the ratio of the viscosity of the sealing agent 70 at 25° C. at 5 rpm to the viscosity at 0.5 rpm. A TI value of the sealing agent 70 can be obtained based on JIS K6833-1:2008. Further, the viscosity of the sealing agent 70 can be measured using a rotary viscometer based on JIS K7117-2.

The viscosity of the sealing agent 70 at 0.5 rpm at 25° C. may be 400,000 Pads or more and 1,100,000 Pads or less, for example. The viscosity of the sealing agent 70 at 0.5 rpm at 25° C. may be 500,000 Pas or more, or 800,000 Pads or more. Further, the viscosity of the sealing agent 70 at 0.5 rpm at 25° C. may be 1,000,000 Pads or less, or 900,000 Pa·s or less.

The viscosity of the sealing agent 70 at 5 rpm at 25° C. may be 50,000 Pa·s or more and 200,000 Pads or less, for example. The viscosity of the sealing agent 70 at 5 rpm at 25° C. may be 80,000 Pads or more, or 100,000 Pads or more. Further, the viscosity of the sealing agent 70 at 5 rpm at 25° C. may be 190,000 Pads or less, or 180,000 Pads or less.

### (Sealing Step)

In the sealing step, the conductor connector 21 is sealed in the space S in the housing 30. Specifically, the entire periphery of the conductor covered portion 14 and the entire periphery of the coupler 23 are sandwiched by the adhesive 60 with a self-adhesive property, formed to the whole circumference of the edge 40a of the first case 40, and the adhesive 60 formed to the whole circumference of the edge 50a of the second case 50. Further, the adhesive 60 formed to the whole circumference of the edge 40a of the first case 40, and the adhesive 60 formed to the whole circumference of the edge 50a of the second case 50 prevent water from entering from between the electric wire 10, and the housing 30 including the first case 40 and second case 50, from between the housing 30 and coupler 23, and from between the first case 40 and second case 50.

This forms the housing 30 including the first case 40 and second case 50, in which the adhesive is disposed between the whole circumference of the edge 40a of the first case 40 and the whole circumference of the edge 50a of the second case 50. The second portion 14b of the conductor covered portion 14, which is disposed more toward the conductor exposed portion 13 than the first portion 14a is sandwiched between a portion of the edge 40a of the first case 40 and a portion of the edge 50a of the second case 50 through the adhesive 60. Due to the entire periphery of the second portion 14b of the electric wire 10 being surrounded by the adhesive 60, water is prevented from entering from between the housing 30 and electric wire 10. Further, the coupler 23 is sandwiched between a portion of the edge 40a of the first case 40 and a portion of the edge 50a of the second case 50 through the adhesive 60. Due to the entire periphery of the coupler 23 being surrounded by the adhesive 60, water is prevented from entering from between the housing 30 and coupler 23. Furthermore, the first portion 14a of the conductor covered portion 14 and the terminal connector 22 are exposed from the housing 30

Further, the conductor connector 21 is sealed in the space S formed by the recess 34, of which entire periphery is surrounded by the first case 40, second case 50, and adhesive 60. The recess 34 is disposed in at least either the first case 40 or second case 50. Therefore, the adhesive 60 prevents water from entering from between the first case 40 and second case 50. By performing the above steps, it is possible to manufacture the electric wire 1 with the connector.

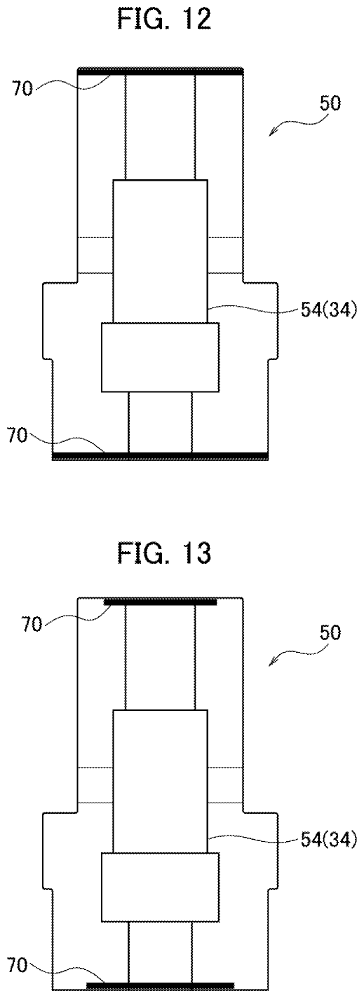

In the second adhesive forming step, as illustrated in FIGS. 10 and 11, the sealing agent 70 is applied and cured to the whole circumference of the edge 50a of the second case 50. However, it is sufficient if the sealing agent 70 is applied and cured to at least the edge of the second case 50 to which the conductor covered portion 14 is attached, and at least the edge of the second case 50 to which the coupler 23 is attached. More specifically, as illustrated in FIG. 12, the sealing agent 70 may be applied and cured to a side of the edge of the second case 50 to which the conductor covered portion 14 is attached. Further, as illustrated in FIG. 12, the sealing agent 70 may be applied and cured to a side of the edge of the second case 50 to which the coupler 23 is attached. As illustrated in FIG. 13, the sealing agent 70 may be applied and cured only to the periphery of the edge of the second case 50, to which the conductor covered portion 14 is attached. As illustrated in FIG. 13, the sealing agent 70 may be applied and cured only to the periphery of the edge of the second case 50, to which the coupler 23 is attached. Furthermore, a position where the sealing agent 70 is applied and cured may be a combination thereof. Even in these aspects, it is possible to manufacture the electric wire 1 with the connector described above.

As described above, the method of manufacturing the electric wire 1 with the connector according to the present embodiment includes a step of connecting the conductor exposed portion 13 of the electric wire 10 to the conductor connector 21 of the terminal 20. The electric wire 10 includes the conductor 11 and the insulation sheath 12 covering the outer periphery of the conductor 11, and further includes therein the conductor exposed portion 13 in which the conductor 11 is exposed from the insulation sheath 12, and the conductor covered portion 14 in which the conductor 11 is covered with the insulation sheath 12. The terminal 20 includes the conductor connector 21 configured to be connected to the conductor exposed portion 13, the terminal connector 22 configured to be connected to a mating terminal, and the coupler 23 for coupling the conductor connector 21 and terminal connector 22. The method of manufacturing the electric wire 1 with the connector includes a step of sealing the conductor connector 21 in the space S. In the sealing step, the entire periphery of the conductor covered portion 14 and the entire periphery of the coupler 23 are sandwiched by the adhesive 60 with a self-adhesive property, formed to the whole circumference of the edge 40a of the first case 40, the adhesive 60 formed to at least the edge of the second case 50 to which the conductor covered portion 14 is attached, and the adhesive 60 formed to at least the edge 50a of the second case 50 to which the coupler 23 is attached. Further, in the sealing step, the adhesive 60 formed to the edge 40a of the first case 40, and the adhesive 60 formed to the edge 50a of the second case 50 prevent water from entering from between the electric wire 10, and the housing 30 including the first case 40 and second case 50, from between the housing 30 and coupler 23, and from between the first case 40 and second case 50. The space S is formed by the recess 34 which is disposed in at least either the first case 40 or second case 50, and the entire periphery of the space S is surrounded by the first case 40, second case 50, and adhesive 60. In accordance with the method of manufacturing the electric wire 1 with the connector according to the present embodiment, it is possible to manufacture the electric wire 1 with the connector described above.

Further, the sealing agent 70 is used in the method of manufacturing the electric wire 1 with the connector according to the present embodiment. This eliminates an assembly step using a rubber component. Therefore, it is possible to contribute to shortening of a lead time.

In addition, the sealing agent 70 is used in the method of manufacturing the electric wire 1 with the connector according to the present embodiment, and this can prevent occurrence of a leakage path at an adhesion portion between the first case 40 and second case 50, at the periphery of the electric wire 10, and at the periphery of the terminal 20. The entire content of Japanese Patent Application No. 2022-166053, filed on Oct. 17, 2022, is incorporated herein.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electric wire with a connector comprising:
an electric wire that includes a conductor and an insulation sheath covering an outer periphery of the conductor, and that includes therein a conductor exposed portion in which the conductor is exposed from the insulation sheath, and a conductor covered portion in which the conductor is covered with the insulation sheath;
a terminal that includes a conductor connector connected to the conductor exposed portion, a terminal connector configured to be connected to a mating terminal, and a coupler coupling the conductor connector and the terminal connector; and
a housing that includes a first case and a second case, and that has an adhesive interposed between a whole circumference of an edge of the first case and a whole circumference of an edge of the second case, wherein
a first portion of the conductor covered portion and the terminal connector are exposed from the housing,
a second portion of the conductor covered portion that is disposed more toward the conductor exposed portion than the first portion is sandwiched between a portion of the edge of the first case and a portion of the edge of the second case through the adhesive, and due to an entire periphery of the second portion of the electric wire being surrounded by the adhesive, water is prevented from entering from between the housing and the electric wire,
the coupler is sandwiched between the portion of the edge of the first case and the portion of the edge of the second case through the adhesive, and due to an entire periphery of the coupler being surrounded by the adhesive, water is prevented from entering from between the housing and the coupler,
a recess is disposed in at least either the first case or the second case, and
the conductor connector is sealed in a space formed by the recess, of which an entire periphery is surrounded by the first case, the second case, and the adhesive, and the adhesive prevents water from entering from between the first case and the second case.

2. A method of manufacturing an electric wire with a connector comprising:
a step of connecting a conductor exposed portion in which a conductor is exposed from an insulation sheath covering an outer periphery of the conductor, to a conductor connector configured to be connected to the conductor exposed portion, the conductor exposed portion being included in an electric wire that includes the conductor and the insulation sheath, and that includes therein the conductor exposed portion and a conductor covered portion in which the conductor is covered with the insulation sheath, the conductor connector being included in a terminal that includes the conductor connector, a terminal connector configured to be connected to a mating terminal, and a coupler coupling the conductor connector and the terminal connector; and
a step of sandwiching an entire periphery of the conductor covered portion and an entire periphery of the coupler by an adhesive with a self-adhesive property formed to a whole circumference of an edge of a first case, an adhesive formed to at least an edge of a second case to which the conductor covered portion is attached, and an adhesive formed to at least an edge of the second case to which the coupler is attached; preventing water from entering from between the electric wire, and a housing including the first case and the second case, from between the housing and the coupler, and from between the first case and the second case by the adhesive formed to the edge of the first case and the adhesive formed to the edge of the second case; and sealing the conductor connector in a space formed by a recess, of which an entire periphery is surrounded by the first case, the second case, and the adhesive, the recess being disposed in at least either the first case or the second case.

3. The method of manufacturing an electric wire with a connector according to claim 2, further comprising:
a step of applying and curing a sealing agent to the edge of the first case to form the adhesive; and
a step of applying and curing the sealing agent to the edge of the second case to form the adhesive.

4. The method of manufacturing an electric wire with a connector according to claim 3, wherein
a thixotropic index value of the sealing agent is two or more.
